(19) United States
(12) Patent Application Publication
(10) Pub. No.: US 2002/0122306 A1
(43) Pub. Date: Sep. 5, 2002

(54) Lighted rock and method therefor

(76) Inventor: Robert O'Connell, Scottsdale, AZ (US)

Correspondence Address: WEISS & MOY PC, 4204 NORTH BROWN AVENUE, SCOTTSDALE, AZ, 85251, US

(21) Appl. No.: 10/093,493

(22) Filed: Mar. 11, 2002

Related U.S. Application Data
(63) Continuation-in-part of application No. 09/613,198, filed on Jul. 10, 2000, now Pat. No. 6,409,359.

(51) Int. Cl. F21S 6/00

(52) U.S. Cl. 362/145; 362/153.1; 362/293

(57) ABSTRACT

An illuminated rock and method having the external appearance of a rock and having a light source inside which transmits light through openings in the rock to an outside viewer. Preferably, the light passes through a diffusion screen so as to obscure the actual light element from view, while allowing sufficient light to pass through the design. The openings define a design that may be of any desired type, and may include a street number, patriotic design, ethnic or religious design, holiday design, or some other design.

### RELATED APPLICATION

This is a Continuation in Part of U.S. Ser. No. 09/613,198, filed Jul. 10, 2000 in the name of the same applicant of this application, and to which priority is claimed.

### FIELD OF THE INVENTION

This invention relates generally to outdoor decoration and, more specifically, to an artificial rock having a design drilled therethrough and having an illumination source therein so that the design may be viewed at night.

### BACKGROUND OF THE INVENTION

For the convenience of visitors, for reasons of safety, and for related reasons, it is generally desirable that a building—particularly a residence—have its address prominently marked and visible. In the residential context, this is often achieved by painting the street address on the mail box, by painting the street address on the curb, or by placing wood or tile numbers on the exterior of the house.

One obvious problem with these methods is that they are generally not readily viewable at night. It is necessary therefore to provide a street address marking that is readily viewed at night. On the other hand, it is also generally desired that the apparatus displaying the street address be aesthetically pleasing. One way of providing an aesthetically pleasing apparatus is to provide one having the appearance of something that might generally be found in the front yard of a home.

It may also be desired, either together with an address or in place thereof, to provide an aesthetically pleasing design that may be positioned in front of a home (or the like) and that is viewable at night. A wide variety of designs could be possible, including but not limited to American (or other) flags, designs associated with holidays (such as ones of having a Christmas or Halloween theme) or designs associated with particular ethnic or religious groups.

Thus, a need existed for a device and method for providing a street address display that is both viewable at night but also aesthetically pleasing during daylight hours. A need further existed for a street address display having the appearance of an item that might generally be found in the front yard of a home. A need still further existed for a device and method for providing a design display having these attributes. The present invention satisfies these needs and provides other, related, advantages.

### SUMMARY OF THE INVENTION

An object of the present invention is to provide a street address display that is viewable at night.

A further object of the present invention is to provide a street address display that is viewable at night but also aesthetically pleasing during daylight hours.

A still further object of the present invention is to provide a street address display that is viewable at night but also aesthetically pleasing during daylight hours and that has the appearance of something that one may expect to find in a typical front yard of a residence.

A yet further object of the present invention is to provide a design display that is viewable at night, aesthetically pleasing during daylight hours, and that has the appearance of something that one may expect to find in a typical front yard of a residence.

### BRIEF DESCRIPTION OF THE PREFERRED EMBODIMENTS

In accordance with one embodiment of the present invention, an illuminated artificial rock is disclosed. The illuminated artificial rock comprises, in combination: an artificial rock having an exterior surface and a hollow interior area; a design formed of a plurality of openings extending through a front portion of the exterior surface and into the hollow interior area; and a light positioned within the hollow interior area and oriented to transmit light through the plurality of openings so as to illuminate the design and thus cause the design to be visible to a person positioned opposite the front portion of the exterior surface.

In accordance with another embodiment of the present invention, a method for providing an illuminated artificial rock is disclosed. The method comprises the steps of: providing an artificial rock having an exterior surface and a hollow interior area; providing a design formed of a plurality of openings extending through a front portion of the exterior surface and into the hollow interior area; and positioning a light within the hollow interior area and orienting the light to transmit light toward the front portion of the exterior surface and through the plurality of openings so as to illuminate the design and thus cause the design to be visible to a person positioned opposite the front portion of the exterior surface.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is a perspective view of an embodiment of an illuminated artificial rock of the present invention.

FIG. 2 is a perspective, exploded view of an illuminated artificial rock of the present invention.

FIG. 3 is a cross-sectional view of the illuminated artificial rock of FIG. 1, taken along lines 3-3.

FIG. 4 is a front view of a stencil having numbers and useable for placing a street address on an illuminated artificial rock of the present invention.

FIG. 5 is a perspective view of another embodiment of an illuminated artificial rock of the present invention.

FIG. 6 is a perspective view of another embodiment of an illuminated artificial rock of the present invention.

FIG. 7 is a perspective view of another embodiment of an illuminated artificial rock of the present invention.

FIG. 8 is a perspective view of another embodiment of an illuminated artificial rock of the present invention.

### DETAILED DESCRIPTION OF THE PREFERRED EMBODIMENTS

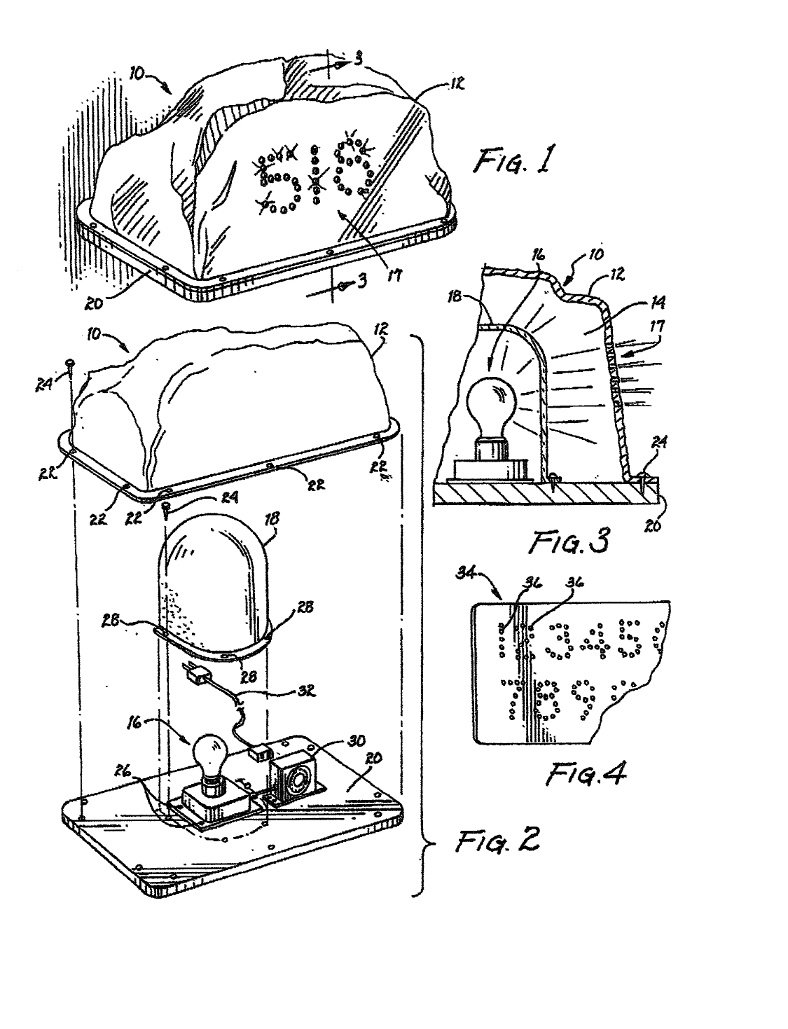

Referring to FIGS. 1-3, the illuminated artificial rock 10 (the “illuminated rock 10”) is shown. The illuminated rock 10 comprises at least the following components: a rock shell 12 having a hollow area 14 therein, a light source 16 located in the hollow area 14, and a design 17 through the rock shell 12 permitting light transmitted from the light source 16 to pass through the rock shell 12 and be visible to an outside observer. The light source 16 may be a low voltage light, of the type commonly used in landscaping. The light source 16 may, preferably, be colored so as to provide a more aesthetically pleasing design 17. As discussed below, the rock shell 12 should not only be shaped like a rock, but should also have coloring so as to give it a natural appearance, so as to increase the camouflage effect and to persuade a casual observer during daylight hours that the rock shell 12 is a genuine rock. The rock shell 12 should, preferably, be positioned proximate the front of a home so as to maximize exposure of the design 17.

As shown in FIGS. 2 and 3, the illuminated rock 10 further preferably includes a diffusion screen 18 positioned between the light source 16 and the design 17. The purpose of the diffusion screen 18 is to diffuse the light transmitted from the light source 16 so as to prevent an outside observer looking at the design 17 from seeing the bulb or other element comprising the light source 16. The diffusion screen 18 may be made from any material—e.g., plastic, glass, etc.—capable of diffusing light, sufficiently able to conceal the element comprising the light source 16, and yet sufficiently transparent to permit the desired amount of light to illuminate the design 17. The diffusion screen 18 may optionally be colored so as to alter or improve the visual appearance of the design 17.

It should be noted that, depending on the light source 16, a diffusion screen 18 may not be necessary. For example, where the light source 16 is a low voltage outdoor light(s), a diffusion screen 18 will generally not be needed.

As shown in FIGS. 1-3, the illuminated rock 10 further preferably comprises a base 20, over which the rock shell 12 (with the light source 16 positioned therein) may be placed. The base 20 may be made from wood, plastic, metal or virtually any reasonably durable material—though is preferably made from a material having at least some resistance to harm caused by being positioned outdoors on the ground, including harm caused by moisture, insects, etc. The rock shell 12 may simply be placed on top of the base 20, with the weight of the rock shell 12 maintaining it in position, or it may be secured through openings 22 about the perimeter of the rock shell 12 using screws 24 as shown in FIGS. 2 and 3. Similarly, the light source 16 may be positioned on the base 20 without the benefit of any additional hardware, or may be secured to the base 20 with screws (not shown) through openings 26 in the base of the light source 16. Still further, the diffusion screen 18 may, optionally, be secured to the base 20 with screws 24 through openings 28 in the base of the diffusion screen—or may be positioned between the light source 16 and design 17 in any one of a variety of other ways.

For some embodiments, a base 20 will not be desired. For example, if the light source 16 is a low voltage outdoor light of a type that may be appropriately coupled to the ground, it will generally be desired to simply place the rock shell 12 over the light source 16, without the need for positioning a base 20 below the light source 16.

Referring specifically to FIG. 2, preferably the illuminated rock 10 further includes a mechanism for automatically turning the light source 16 on and off at the desired times. One such mechanism is an electric timer 30, into which the light source 16 may be coupled and which electric timer 30 may then be attached to a power source (not shown) with chord 32. Other mechanisms for automatically turning the light source 16 on and off would be possible, including the use of a light sensor capable of detecting when the ambient light falls below a certain level—at which point the light source 16 would be activated—and then deactivating the light source 16 when the ambient light falls above a certain level. Such light detectors are well known in the art.

Referring now to FIGS. 1 and 4, the design 17 in its street number embodiment is discussed. In this regard, the design 17 could be any desired, aesthetically pleasing design—such as a name, one or more letters, one or more numbers, a shape, or any combination thereof—and is not necessarily limited to a street number. However, in the preferred embodiment, the design 17 is a street number. The design 17 in its street number embodiment or otherwise is preferably formed by drilling a series of holes all the way through exterior surface of the rock shell 12, so as to permit light to pass from the light source 16 through the rock shell 12 where it can be viewed by an outside observer.

Preferably, this drilling is accomplished by the use of a stencil 34, preferably having thereon numbers 36 (ranging from 0 to 9), each of which is formed by a series of holes as shown in FIG. 4. (While the stencil 34 preferably has a plurality of numbers 36, it would be possible to have a series of individual stencils 34, each having only a single number 36—one each for numbers 0 through 9.) In this regard, the stencil 34 may be taped to the rock shell 12 in the position desired for placement of the design 17. The numbers 36 may then be traced onto the rock shell 12 through the stencil 34, for example using a washable marker. The stencil 34 may then be removed, and the tracing followed by making a series of holes with an electric drill, with any excess marker to be wiped away. Assuming the rock shell 12 is formed of boat resin or like material, a steel bit is preferably used, with a 5/32″ size preferred.

While the use of a stencil 34 in the manner described above is preferred in the creation of the design 17, the design 17 may be created in any desired way. For example, a large space could be cut into the rock shell 12, into which could be inserted and secured a plate or dark plastic piece having a street number or other design drilled thereon.

The steps of creating the rock shell 12 are preferably as follows:

1. A mold is first formed, preferably from fiberglass, in the shape of a rock having an open bottom. In forming the mold and in the interest of creating greater realism, real rocks may used, with the fiberglass being formed over the real rocks.

2. The mold is inverted so that the open bottom is facing upward. The inside surface of the mold is coated with a Johnson paste wax or an aerosol release agent, to allow the finished rock shell 12 to be readily removed from the mold and to provide a sticky base for the colors (discussed below) to adhere.

3. Coloring, preferably in the form of powdered cement colors, is lightly sprinkled into the mold, taking care to try to cover as much of the surface of the mold as possible. A small brush may be used to assist in the proper distribution of the coloring. Where a brown color is desired, brown, yellow and black powdered cement colors should be used in combination. Where a gray color is desired, gray, yellow and black powdered cement colors should be used in combination.

4. The material to form the rock shell 12 is created and used to line the mold over the coloring. Preferably, the material used is a composition of boat resin, a catalyst, high fiber powder, and a small amount of liquid white color pigment. This composition should be mixed to a paste-like consistency.

5. A single coating of the boat resin composition should be applied to the entire interior of the mold over the coloring, using either a paint brush or a sprayer with a large nozzle opening.

6. Fiberglass matting should be cut into pieces, preferably about eight inches in length, and used to cover the coating of the boat resin composition.

7. The fiberglass matting layer should be covered with a second coating of the boat resin composition.

8. The layers of boat resin material should be allowed to set up, preferably for about 30 to 45 minutes. When the material pulls easily away from the mold and slightly snaps back, it is ready to be removed. After removal, the rock shell 12 should be allowed to harden on a flat surface, preferably for approximately four to six hours.

While these represent the preferred steps for creating the rock shell 12, essentially any method resulting in an artificial rock shell 12 would be within the spirit or scope of the present invention.

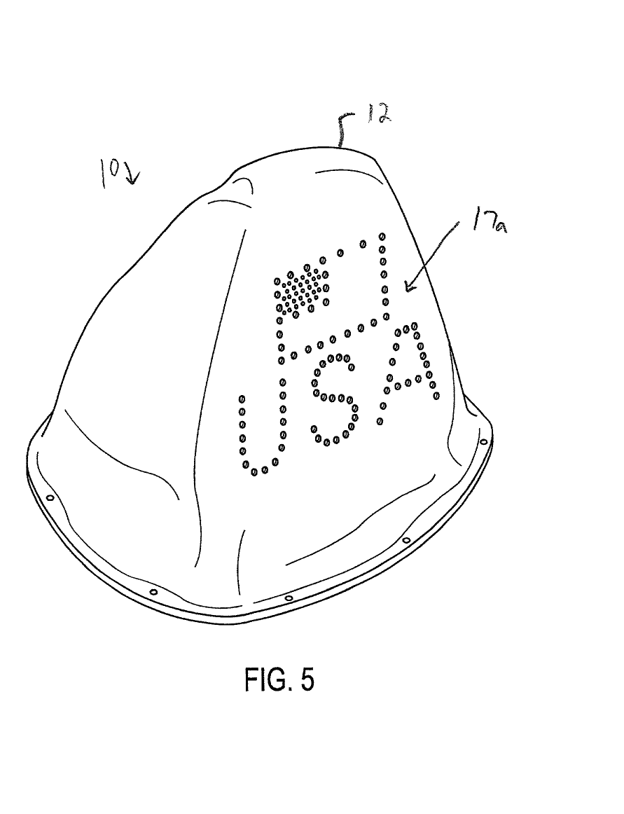

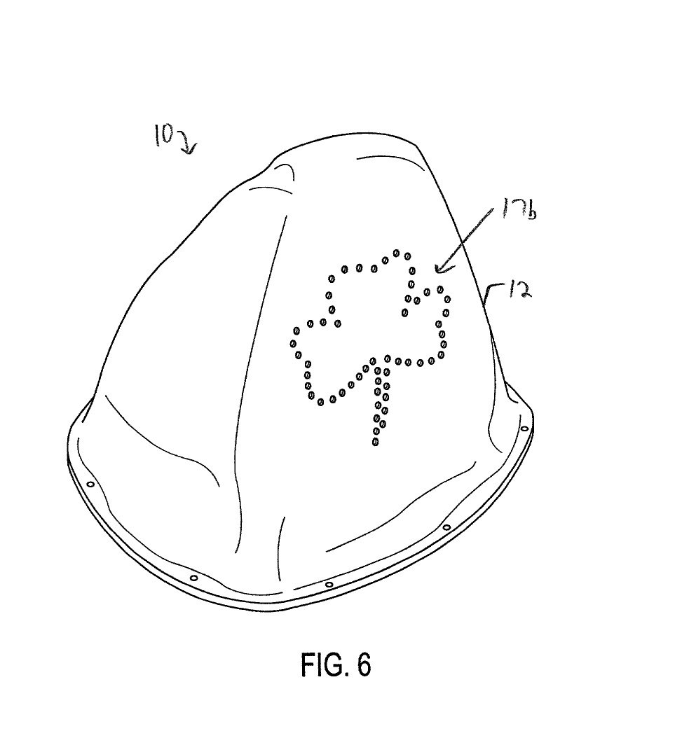

Referring now to FIGS. 5-8, other embodiments of the illuminated rock 10 are shown, illustrate exemplary (but by no means a full listing) of different categories of designs 17 that may be utilized. For example, referring first to FIG. 5, a design 17a is shown consisting of a depiction of an American Flag and the words “USA.” This is exemplary of a design 17 having a patriotic message, and such a message can be expressed using different specific symbols, words, flags, etc. In this embodiment, it may be preferred to utilize either a multi-colored light source 16 or multiple, differently colored diffusion screens 18 to create the effect of a multi-colored design 17. (It may also be preferred to position the diffusion screens 18 on an interior surface of the rock shell 12, as opposed to surrounding the light source 16 as shown in FIGS. 2-3.)

Referring now to FIG. 6, a design 17b is shown consisting of a depiction of a Shamrock. This is exemplary of a design 17 conveying an ethnic or religious theme, and, of course, such a message can be expressed using a variety of different specific symbols.

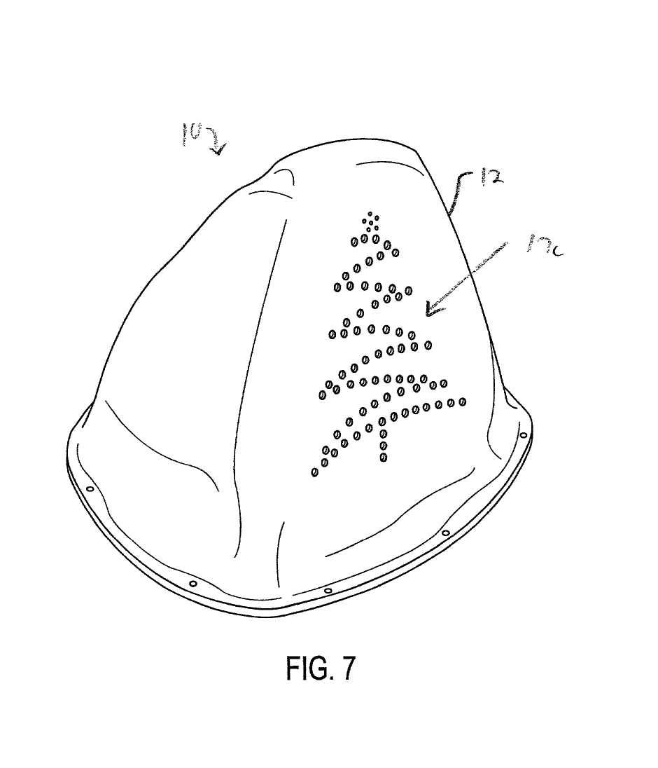

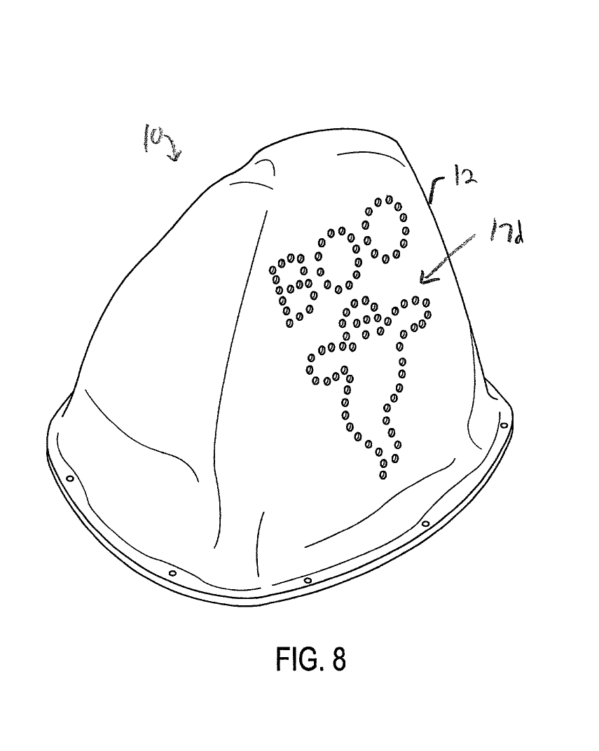

Referring now to FIG. 7, a design 17c is shown consisting of a depiction of a Christmas Tree. Referring to FIG. 8, a design 17d is shown consisting of a depiction of a ghost and the word “BOO.” These are meant to be exemplary of a design 17 having a holiday theme and, of course, such a message can be expressed using a variety of different specific symbols.

It should be noted that the designs 17a-d illustrated in FIGS. 5-8—or any variations thereon—may be employed as part of or in addition to a number address as shown in FIG. 1, or in place thereof.

Of course, designs 17 may be desired that do not fall into one of the “theme” categories exemplified in FIGS. 5-8, and the designs 17 illustrated therein are also intended to generally illustrate that a design 17 can be any desired design capable of being expressed in a rock 12 with a plurality of openings therethrough, permitting such design 17 to be illuminated. In addition to the examples provided, the design 17 could be purely decorative, political, or again could convey any design desired by a particular user and capable of expressed in the manner described herein. Thus, except as specifically claimed, the term “design” is not intended to be limited to any of the specific embodiments disclosed herein.

While the invention has been particularly shown and described with reference to preferred embodiments thereof, it will be understood by those skilled in the art that the foregoing and other changes in form and details may be made therein without departing from the spirit and scope of the invention.

I claim:

1. An illuminated artificial rock comprising, in combination:
an artificial rock having an exterior surface and a hollow interior area;
a design formed of a plurality of openings extending through a front portion of said exterior surface and into said hollow interior area; and
a light positioned within said hollow interior area and oriented to transmit light through said plurality of openings so as to illuminate said design and thus cause said design to be visible to a person positioned opposite said front portion of said exterior surface.

2. The illuminated artificial rock of claim 1 wherein said artificial rock is comprised of fiberglass.

3. The illuminated artificial rock of claim 1 wherein said design expresses a patriotic theme.

4. The illuminated artificial rock of claim 1 wherein said design express an ethnic theme.

5. The illuminated artificial rock of claim 1 wherein said design express a holiday theme.

6. The illuminated artificial rock of claim 1 further comprising a diffusion screen positioned between said light and said plurality of openings.

7. The illuminated artificial rock of claim 1 further comprising means for automatically turning said light on and off.

8. The illuminated artificial rock of claim 7 wherein said means comprises a timer.

9. The illuminated artificial rock of claim 1 further comprising a base positioned below said light and said artificial rock and dimensioned to cover a bottom portion of said hollow interior area.

10. The illuminated artificial rock of claim 1 wherein said light is colored.

11. A method for providing an illuminated artificial rock comprising the steps of:
providing an artificial rock having an exterior surface and a hollow interior area;
providing a design formed of a plurality of openings extending through a front portion of said exterior surface and into said hollow interior area; and
positioning a light within said hollow interior area and orienting said light to transmit light toward said front portion of said exterior surface and through said plurality of openings so as to illuminate said design and thus cause said design to be visible to a person positioned opposite said front portion of said exterior surface.

12. The method of claim 11 wherein said step of providing an artificial rock further comprises the steps of:
providing a mold in the shape of a rock;
coating an inside surface of said mold with a release agent;
applying to said inside surface over said release agent colors;
applying a first layer of boat resin over said release agent colors;
applying a layer of fiberglass matting material to said layer of said boat resin;
applying a second layer of said boat resin over said layer of fiberglass matting material;
allowing said first layer and said second layer to set up and to thereby form said artificial rock; and
removing said artificial rock from said mold.

13. The method of claim 12 wherein said release agent is wax.

14. The method of claim 12 wherein said colors comprise at least one cement color.

15. The method of claim 11 wherein said design expresses a patriotic theme.

16. The method of claim 11 wherein said design expresses an ethnic theme.

17. The method of claim 11 wherein said design expresses a holiday theme.

18. The method of claim 11 wherein said step of providing said design further comprises the steps of:
providing a stencil having at least one opening therethrough;
positioning said stencil upon an exterior surface of said artificial rock; and
drilling openings in said exterior surface of said artificial rock corresponding to openings on said stencil.

19. The method of claim 11 further comprising the step of providing a diffusion screen positioned between said light and said plurality of openings.

20. The method of claim 11 further comprising the step of providing a base positioned below said light and said artificial rock and dimensioned to cover a bottom portion of said hollow interior area.
